(19) United States
(12) Patent Application Publication
(10) Pub. No.: US 2013/0162499 A1
(43) Pub. Date: Jun. 27, 2013

(54) APPARATUS FOR IMPLEMENTING CROSS POLARIZED INTEGRATED ANTENNAS FOR MIMO ACCESS POINTS

(71) Applicants: Jeffrey L. Pochop, JR., Los Gatos, CA (US); Michael L. Smith, Orinda, CA (US); Tash Hepting, Livermore, CA (US)

(72) Inventors: Jeffrey L. Pochop, JR., Los Gatos, CA (US); Michael L. Smith, Orinda, CA (US); Tash Hepting, Livermore, CA (US)

(73) Assignee: JUNIPER NETWORKS, INC., Sunnyvale, CA (US)

(21) Appl. No.: 13/538,545

(22) Filed: Jun. 29, 2012

Related U.S. Application Data
(60) Provisional application No. 61/559,854, filed on Nov. 15, 2011.

(51) Int. Cl. H01Q 21/24

(52) U.S. Cl. CPC H01Q 21/24
USPC 343/893

(57) ABSTRACT

An apparatus includes a processor disposed within an enclosure and configured to connect one or more wireless devices to a network. A first antenna has an orientation of polarization and is disposed within the enclosure. A second antenna has an orientation of polarization and is disposed within the enclosure at a non-zero distance from first antenna. A third antenna has an orientation of polarization and is disposed within the enclosure at a non-zero distance from each of the first antenna and the second antenna. The orientation of polarization of the first antenna is different from the orientation of polarization of the second antenna, and the orientation of polarization of the third antenna is different from the orientation of polarization of the first antenna and the orientation of polarization of the second antenna.

### CROSS-REFERENCE TO RELATED APPLICATIONS

This application claims priority to and the benefit of U.S. Provisional Application Ser. No. 61/559,854, entitled “Methods and Apparatus for Implementing Cross Polarized Integrated Antennas for MIMO Access Points,” filed on Nov. 15, 2011, the disclosure of which is incorporated herein by reference in its entirety.

This application is also related to co-pending U.S. nonprovisional patent application having Attorney Docket No. JUNI-178/01US, filed on the same date as this application, which claims priority to U.S. Provisional Application Ser. No. 61/559,859, filed on Nov. 15, 2011 each entitled “Methods and Apparatus for Balancing Band Performance,” and co-pending U.S. Provisional Application Ser. No. 61/559,863, filed on Nov. 15, 2011 and entitled “Methods and Apparatus for Thermal Management in a Wireless Access Point,” each of which is incorporated by reference herein in its entirety.

### BACKGROUND

Some embodiments described herein relate generally to an apparatus for providing communications between wireless communication devices and a network, using, for example, cross polarized integrated antennas for multiple input-multiple output (MIMO) access points.

Antenna diversity is a scheme that uses multiple antennas to improve the quality and reliability of a wireless link. Often, when no clear line-of-sight (LOS) exists between a transmitter and a receiver, the signal can be reflected along multiple paths before finally being received. In such scenarios, multiple antennas at the receiver can provide several observations of the same signal that are received via the multiple paths. Each antenna of the multiple antennas can experience different interference along the corresponding path. Thus, if one antenna is experiencing a deep fade, another antenna likely has a sufficient signal. Collectively, such a system can provide a robust wireless link. Similarly, multiple antennas can be proven valuable for transmitting systems as well as the receiving systems. As a result, antenna diversity at the transmitter and/or the receiver can be effective at mitigating multipath situations and providing an overall improved performance for the wireless link.

As an example, for multi-stream IEEE 802.11n MIMO (multiple-input and multiple-output) protocol, the better the receiver is able to isolate and differentiate between data streams received along different paths, the higher performance can be achieved for a wireless link. In this example, one or more antenna techniques can be implemented to enhance the antenna diversity, i.e., to isolate and differentiate data streams received along different paths. Such antenna techniques can include, for example, spatial diversity, pattern diversity, polarization diversity, and/or the like.

Some known MIMO access points implement cross-polarized antennas to achieve polarization diversity. Because these cross-polarized antennas are typically larger than a small form-factor access point, these antennas are typically not integrated into the small form-factor access point but located external to the access point. Some other known MIMO access points implement a single-polarized (i.e., with a specific polarization) antenna internal to the small form-factor access point, as well as use pattern diversity and spatial diversity. Such known MIMO access points, however, do not include internal cross-polarized antennas. As a result, many of these MIMO access points include external cross-polarized antennas or external articulating antennas that are recommended to be placed in cross-polarized orientations.

Accordingly, a need exists for a small form-factor multi-stream MIMO access point device that can use internal cross-polarized antennas to provide polarization diversity in addition to pattern diversity and spatial diversity.

### SUMMARY

An apparatus includes a processor disposed within an enclosure and configured to connect one or more wireless devices to a network. A first antenna has an orientation of polarization and is disposed within the enclosure. A second antenna has an orientation of polarization and is disposed within the enclosure at a non-zero distance from first antenna. A third antenna has an orientation of polarization and is disposed within the enclosure at a non-zero distance from each of the first antenna and the second antenna. The orientation of polarization of the first antenna is different from the orientation of polarization of the second antenna, and the orientation of polarization of the third antenna is different from the orientation of polarization of the first antenna and the orientation of polarization of the second antenna.

### BRIEF DESCRIPTION OF THE DRAWINGS

FIG. 1A is a schematic illustration of a wireless access point device, according to an embodiment

FIG. 1B is a schematic illustration of an example of orientations of polarization of internal antennas within the wireless access point device of FIG. 1A viewed from a bottom of the wireless access point device; and FIG. 1C is a schematic illustration of the orientations of polarization of the internal antennas of FIG. 1B viewed from a side of the wireless access point device.

FIG. 1D is a schematic illustration of another example of orientations of polarization of internal antennas within the wireless access point device of FIG. 1A viewed from a bottom of the wireless access point device; and FIG. 1E is a schematic illustration of the orientations of polarization of the internal antennas of FIG. 1C viewed from a side of the wireless access point device.

FIG. 2 is a schematic illustration of the wires access point device of FIG. 1A within a network environment.

FIG. 3 is a top perspective view of a wireless access point device, according to an embodiment.

FIG. 4 is a bottom perspective view of the wireless access point device of FIG. 3.

FIG. 5 is a bottom view of the wireless access point device of FIG. 3.

FIGS. 6 and 7 are each a schematic illustration of a different internal antenna of the wireless access point device of FIG. 5.

FIGS. 8 and 9 illustrate examples of radiation patterns for the internal antennas of FIGS. 6 and 7, respectively.

FIGS. 10 and 11 are each a schematic illustration of a different internal antenna of the wireless access point device of FIG. 5.

FIGS. 12 and 13 illustrate examples of radiation patterns for the internal antennas of FIGS. 10 and 11, respectively.

FIG. 14 is a bottom perspective view of a portion of a wireless access point device with a portion of an enclosure removed, according to another embodiment.

FIG. 15 is a bottom perspective view of the wireless access point device of FIG. 14 with a portion of the enclosure shown transparent.

FIG. 16A is a schematic illustration of an example of orientations of polarization of internal antennas within the wireless access point device of FIG. 14 viewed from a bottom of the wireless access point device; FIG. 16B is a schematic illustration of example orientations of polarization of the internal antennas of FIG. 16A that operate in the 2.4 GHz band viewed from a side of the wireless access point device in a direction of arrow A; and FIG. 16C is a schematic illustration of example orientations of polarization of the internal antennas of FIG. 16A that operate in the 5.0 GHz band viewed from a side of the wireless access point device in a direction of arrow B.

FIG. 17 illustrates an example horizontal-plane radiation pattern for the internal antennas of the wireless access point device of FIG. 14 that operate in the 2.4 GHz band; and

FIG. 18 illustrates an example horizontal-plane radiation pattern for the internal antennas of the wireless access point device of FIG. 14 that operate in the 5.0 GHz band.

FIG. 19 illustrates an example vertical-plane radiation pattern for the internal antennas of the wireless access point device of FIG. 14 that operate in the 2.4 GHz band; and

FIG. 20 illustrates an example vertical-plane radiation pattern for the internal antennas of the wireless access point device of FIG. 14 that operate in the 5.0 GHz band.

### DETAILED DESCRIPTION

In some embodiments, internal cross-polarized antennas can be implemented in a small form-factor multi-stream MIMO access point. In such embodiments, each of the antennas can be positioned within the access point in, for example, a vertical polarization or a horizontal polarization. The MIMO access point can be a dual-radio access point, in that the internal antennas of the access point can operate in both the 2.4 GHz band and the 5.0 GHz band. The implementation of cross-polarized internal antennas typically involves considerations in various aspects, such as radio frequency (RF), thermal characteristics, mechanical mechanisms, electrical mechanisms, and/or the like. Furthermore, in some embodiments, the polarization diversity can be achieved in the design of the small form-factor MIMO access point in addition to the standard pattern diversity and spatial diversity. As a result, a maximum diversity among internal antennas within the multi-stream MIMO access point can be obtained, improving the performance of the access point.

In some embodiments, a small form-factor access point includes internal antennas with pattern, spatial, and polarization diversity. Particularly, in some embodiments, a small form-factor multi-stream MIMO radio based system (e.g., access point) can have internal antennas with polarization diversity in addition to the standard pattern diversity and spatial diversity.

As used herein, “associated with” can mean, for example, included in, physically located with, a part of, and/or operates or functions as a part of. Additionally, “associated with” can mean, for example, references, identifies, characterizes, describes, and/or sent from. For example, an orientation of polarization can be associated with an internal antenna of an access point and identifies, references and/or relates to the internal antenna. As used herein, the singular forms “a,” “an” and “the” include plural referents unless the context clearly dictates otherwise. Thus, for example, the term “a wireless communication device” is intended to mean a single wireless communication device or a combination of wireless communication devices.

As used herein, the polarization of an antenna relates to the orientation of the electric field (E-plane) of an electromagnetic wave sent from or received by that antenna with respect to the Earth's surface and can be determined by the physical structure of the antenna and by its orientation. The use herein of the terms vertically-polarized antenna and horizontally-polarized antenna can refer to the structure of the antenna and/or to the orientation of the antenna within an access point. The orientation of the electric field of the electromagnetic wave (referred to herein as the orientation of polarization) of both a vertically-polarized antenna and a horizontally-polarized antenna can be horizontal, vertical, or at an angle in-between horizontal and vertical, depending on the antenna's orientation within the access point. An antenna with an orientation of polarization that is vertical can send and receive electromagnetic waves orthogonal to electromagnetic waves of an antenna with an orientation of polarization that is horizontal. It should be understood that although many embodiments described herein include vertically-polarized antenna(s) and horizontally-polarized antenna(s), other embodiments can include different or additional antennas with different polarizations such as circular polarization and/or elliptical polarization.

As used herein, the term “omnidirectional antenna” can refer to an antenna which radiates electromagnetic wave power uniformly in all directions in one plane, with the radiated power decreasing with elevation angle above or below the plane. An omnidirectional antenna as described herein can also refer an antenna which radiates electromagnetic wave power substantially in all directions in one plane.

As used herein the term “antenna gain” refers to, for example, an antenna's power gain, and can combine the antenna's directivity and electrical efficiency. For example, as a transmitting antenna, the antenna gain can describe how well the antenna converts input power into electromagnetic waves headed in a specified direction. As a receiving antenna, the antenna gain can describe how well the antenna converts electromagnetic waves arriving from a specified direction into electrical power. When no direction is specified, antenna gain can refer to the peak value of the antenna gain. A plot of the antenna gain as a function of direction is called a radiation pattern.

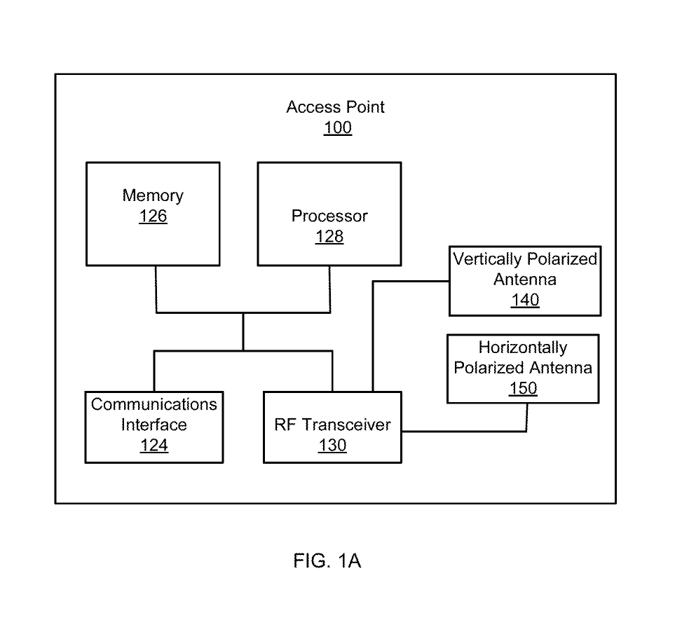

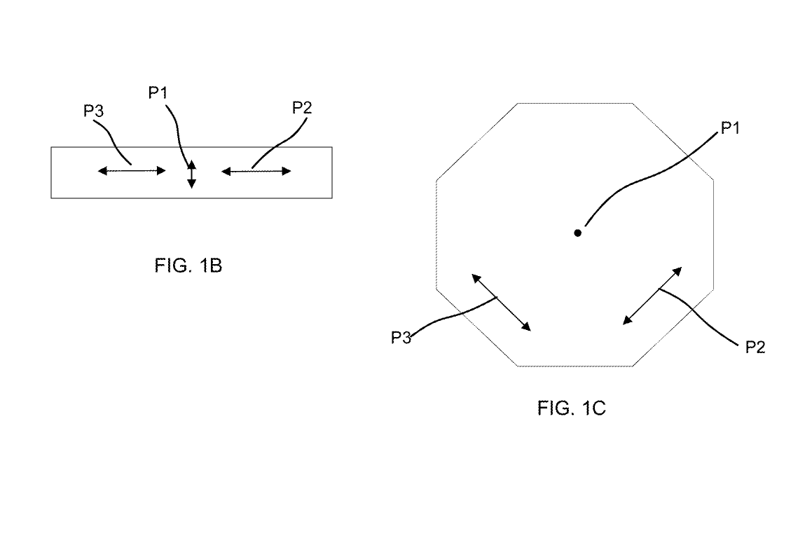

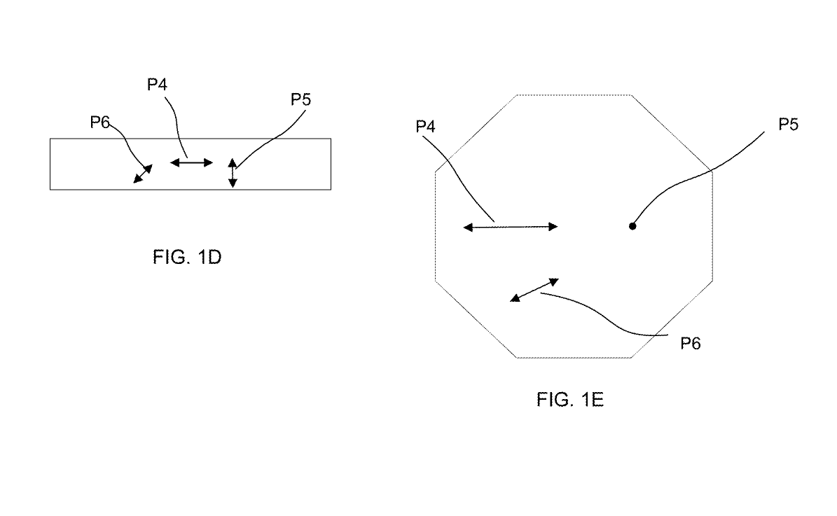

FIG. 1 is a schematic illustration of a wireless access point device according to an embodiment. A wireless access point device 100 can be, for example, an orthogonal frequency-division multiplexing (OFDM) transceiver device. The wireless access point device 100 can communicate with one or more wireless communication devices (not shown in FIG. 1) and can provide communication between the wireless communication devices and a network, such as a local area network (LAN), a wide area network WAN), and/or a network such as, for example, the Internet, as described in more detail below.

As shown in FIG. 1, the wireless access point device 100 (also referred to herein as “access point” or “access point device”) can include a processor 128, a memory 126, a communications interface 124 and a radio frequency (RF) transceiver 130. The access point 100 can include a combination of hardware modules and/or software modules (e.g., stored in memory and/or executing in a processor). Each component of access point 100 is operatively coupled to each of the remaining components of access point 100. Furthermore, each operation of RF transceiver 130 (e.g., transmit/receive data), communications interface 124 (e.g., transmit/receive data), as well as each manipulation on memory 126 (e.g., update an up-link policy table), are controlled by processor 128.

Processor 128 can be operatively coupled to memory 126 and communications interface 124. Communications interface 124 can provide for or establish one or more wired and/or wireless data connections, such as connections conforming to one or more known information exchange standards, such as wired Ethernet, wireless 802.11x (“Wi-Fi”), high-speed packet access (“HSPA”), worldwide interoperability for microwave access (“WiMAX”), wireless local area network (“WLAN”), Ultra-wideband (“UWB”), Universal Serial Bus (“USB”), Bluetooth®, infrared, Code Division Multiple Access (“CDMA”), Time Division Multiple Access (“TDMA”), Global Systems for Mobile Communications (“GSM”), Long Term Evolution (“LTE”), broadband, fiber optics, telephony, and/or the like.

Memory 126 can be, for example, a read-only memory (“ROM”); a random-access memory (“RAM”) such as, for example, a magnetic disk drive, and/or solid-state RAM such as static RAM (“SRAM”) or dynamic RAM (“DRAM”); and/or FLASH memory or a solid-data disk (“SSD”). In some embodiments, a memory can be a combination of memories. For example, a memory can include a DRAM cache coupled to a magnetic disk drive and an SSD.

The processor 128 can be any of a variety of processors. Such processors can be implemented, for example, as hardware modules such as embedded microprocessors, Application-Specific Integrated Circuits (“ASICs”), and Programmable Logic Devices (“PLDs”). Some such processors can have multiple instruction-executing units or cores. Such processors can also be implemented as one or more software modules (e.g., stored in memory and/or executing in a processor) in programming languages such as, for example, Java™, C++, C, assembly, a hardware description language, or any other suitable programming language. A processor according to some embodiments includes media and computer code (also can be referred to as code) specially designed and constructed for the specific purpose or purposes. In some embodiments, the processor 128 can support standard HTML, and software languages such as, for example, JavaScript, JavaScript Object Notation (JSON), Asynchronous JavaScript (AJAX).

In some embodiments, the processor 128 can be, for example, a single physical processor such as a general-purpose processor, an ASIC, a PLD, or a FPGA having a single processing core or a group of processing cores. Alternatively, the processor 128 can be a group or cluster of processors such as a group of physical processors operatively coupled to a shared clock or synchronization signal, a shared memory, a shared memory bus, and/or a shared data bus. In other words, a processor can be a group of processors in a multi-processor computing device. In yet other alternatives, the processor 128 can be a group of distributed processors (e.g., computing devices with one or more physical processors) operatively coupled one to another via a separate communications network (not shown). Thus, the processor 128 can be a group of distributed processors in communication one with another via a separate communications network (not shown). In some embodiments, a processor can be a combination of such processors. For example, a processor can be a group of distributed computing devices, where each computing device includes a group of physical processors sharing a memory bus and each physical processor includes a group of processing cores.

The access point 100 also includes one or more vertically-polarized internal antenna 140 and one or more horizontally-polarized antennas 150 (collectively also referred to as “the internal antennas”). The vertically-polarized antenna(s) 140 can be for example, an omnidirectional, vertically-polarized antenna that operates in the 2.4 GHz band or operates in the 5.0 GHz band. The horizontally-polarized antenna(s) 150 can be, for example, an omnidirectional, horizontally-polarized antenna that operates in the same band as the vertically-polarized internal antenna 140 (e.g., the 2.4 GHz band or the 5.0 GHz band). For example, in some embodiments, the access point 100 can include a vertically-polarized internal antenna 140 and two horizontally-polarized antennas 150 each operating in the 2.4 GHz band or the 5.0 GHz band. In other embodiments, the access point 100 can include a horizontally-polarized internal antenna 150 and two vertically polarized antennas 140 each operating in the 2.4 GHz band or the 5.0 GHz band.

In some embodiments, the access point 100 can include one or more horizontally-polarized antenna 150 and one or more vertically-polarized antennas 140 that operate in the 2.4 GHz band, and one or more horizontally-polarized antenna 150 and one or more vertically-polarized antennas 140 that operate in the 5.0 GHz band. For example, in some embodiments, the access point 100 can include a first vertically-polarized internal antenna 140 and two horizontally-polarized antennas 150 each operating in the 5.0 GHz band, and a second vertically-polarized internal antenna (not shown in FIG. 1) and two horizontally-polarized internal antenna (not shown in FIG. 1) each operating in the 2.4 GHz band. In some embodiments, the access point 100 can include a first horizontally-polarized internal antenna 150 and two vertically-polarized antennas 140 each operating in the 5.0 GHz band, and a second horizontally-polarized internal antenna 150 and two vertically-polarized internal antenna 140 each operating in the 2.4 GHz band.

Thus, in some embodiments, the access point 100 can be dual-radio multiple input—multiple output (MIMO) access point that is enabled to operate concurrently in both the 2.4 GHz band (e.g., 802.11b/g/n) and the 5.0 GHz band (e.g., 802.11a/n). In other embodiments, the access point 100 can be, for example, a dual radio high-performance indoor access point that supports 802.11a/b/g/n/ac on both radios. In yet other embodiments, the access point 100 can be equipped with external antenna ports for use with extra indoor or outdoor antennas. In yet another embodiment, the access point 100 can be, for example, a single radio high-performance indoor access point that supports 802.11a/b/g/n/ac.

The internal antennas (e.g., 140, 150) can be in a ceiling mounted orientation within an enclosure (not shown) of the access point 100. In the ceiling mounted orientation, the vertically-polarized internal antenna 140 will have an orientation of polarization that is substantially vertical and the horizontally-polarized internal antennas 150 will have an orientation of polarization that is substantially horizontal when the access point 100 is viewed from a side view. In alternative embodiments, the access point 100 can be configured to be mounted in any other suitable mounting orientation, such as a wall mounted orientation.

The internal antennas 140, 150 of access point 100 can be positioned within the enclosure of the access point 100 at a non-zero distance from each other such that the access point 100 can provide or support spatial diversity. The internal antennas 140, 150 can also have different radiation patterns to provide or support pattern diversity. Further, as described below, the combination of vertical and horizontal orientation of the polarization of the internal antennas 140, 150 also provides for polarization diversity of the access point 100.

As described above, for multi-stream IEEE 802.11n MIMO (multiple-input and multiple-output) protocol, the better the access point is able to isolate and differentiate between data streams from different paths (e.g., received at different antennas), the higher performance can be achieved for a wireless link. In this example, one or more antenna techniques can be implemented to enhance the antenna diversity, i.e., to isolate multiple data streams (e.g., received at different antennas). Such antenna techniques can include, for example, spatial diversity, pattern diversity, and polarization diversity.

Specifically, spatial diversity employs multiple antennas that are physically separated from one another. The space between two antennas can range from, for example, a space on the order of a wavelength to a long distance of miles. The multiple antennas used in spatial diversity typically have several of the same characteristics. Pattern diversity employs multiple antennas that are co-located with different radiation patterns. This type of diversity typically uses directive antennas that are physically separated by some short distance (e.g., within a wavelength). Collectively, the multiple directive antennas can typically provide a higher gain than a single omnidirectional antenna. Polarization diversity typically combines pairs of cross-polarized antennas (i.e., antennas with orthogonal polarizations, such as horizontal and vertical, +slant 45° and −slant 45°, etc.) to immunize a system from polarization mismatches that would potentially otherwise cause signal fade.

FIGS. 1B and 1C illustrate an example of the orientation of polarization associated with the internal antennas 140, 150 of an access point 100 having two horizontally-polarized internal antennas 150 and a single vertically-polarized internal antenna 140. As shown in the side view of FIG. 1B, an orientation of polarization P1 of the vertically-polarized internal antenna 140 is substantially vertical and the orientations of polarization P2 and P3, of two horizontally-polarized antennas 150, is substantially horizontal (within the same plane). Thus, in the side view, two distinct orientations of polarization of the access point 100 exist. When viewed from a bottom view of the access point 100, as shown in FIG. 1C, the orientation of polarization P1 of the vertically-polarized internal antenna 140 is substantially vertical and the orientation of polarization P2 of the horizontally-polarized internal antenna 150 is in a first orientation and the orientation of polarization P3 of the other horizontally-polarized internal antenna 150 is in a second orientation different than the first orientation. Thus, in the bottom view, three distinct orientations of polarization of the access point 100 exist. In other words, when viewed in a first plane (e.g., in the side view), the orientation of polarization of one of the horizontally-polarized internal antennas 150 substantially corresponds to the orientation of polarization of the other horizontally-polarized antenna 150, but when viewed in another plane (e.g., a bottom view) the orientations of polarization of the two horizontally-polarized internal antennas 150 are different. The multiple orientations of polarization allow the access point 100 to provide for polarization diversity in addition to spatial and pattern diversity provided for by the physical location of the internal antennas relative to each other.

FIGS. 1D and 1E illustrate an example of the orientation of polarization associated with the internal antennas 140, 150 of an access point 100 having two vertically-polarized internal antennas 140 and a single horizontally-polarized internal antenna 150. As shown in the side view of FIG. 1C, an orientation of polarization P4 of the horizontally-polarized internal antenna 150 is substantially horizontal, an orientation of polarization P5 of a first vertically polarized internal antenna 140 is substantially vertical, and an orientation of polarization P6 of a second vertically-polarized internal antenna 140 is at an angle relative to the orientation of polarization P5 of the first vertically-polarized internal antenna 140. For example, the second vertically-polarized internal antenna 140 can be disposed such that the orientation of polarization of the second vertically-polarized internal antenna is at any angle greater than zero and less than 90 degrees relative to the first vertically-polarized internal antenna 140. In some embodiments, instead of the first vertically-polarized internal antenna 140 having an orientation of polarization substantially vertically oriented (e.g., at a 90 degree angle relative to the mounting surface to which the access point is mounted) both the first vertically and second vertically-polarized internal antennas can have an orientation of polarization at an angle less than 90 degrees relative to a mounting surface to which the access point is mounted. In this example, in the side view, three distinct orientations of polarization of the access point 100 exist. When viewed from a bottom view of the access point 100, as shown in FIG. 1E, the orientation of polarization P5 of the first vertically-polarized internal antenna 140 is substantially vertical and the orientation of polarization P6 of the second-vertically polarized internal antenna 140 is in a first orientation and the orientation of polarization of the horizontally-polarized internal antenna 150 is in a second orientation different than the first orientation. Thus, as seen in the bottom view, as in the side view of FIG. 1D, three distinct orientations of polarization of the access point 100 exist. The multiple orientations of polarization allow the access point 100 to provide for polarization diversity in addition to spatial and pattern diversity provided for by the physical location of the internal antennas relative to each other and the radiation pattern associated with each internal antenna.

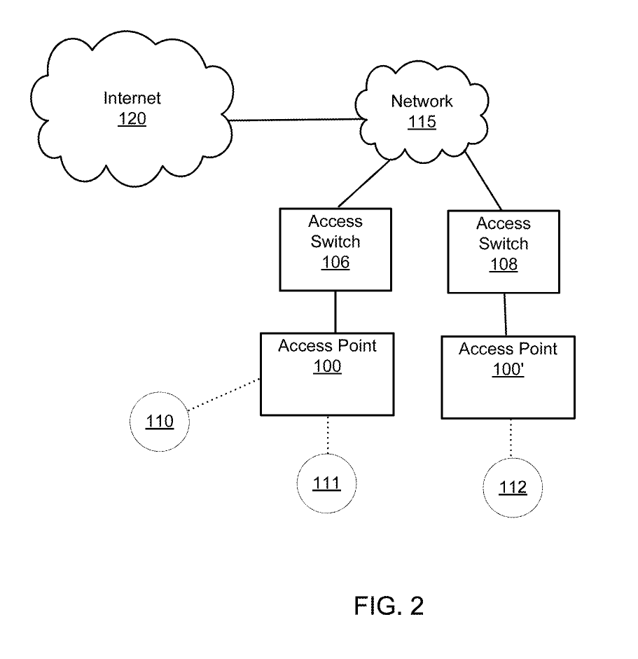

As shown in FIG. 2, the access point 100 can communicate with one or more wireless communications devices, such as the wireless communication devices 110 and 111. For example, the wireless communication devices 110 and 111 can send signals to and receive signals from the access point 100. The access point 100 can provide communication between the wireless communications devices 110, 111 and a network 115 and/or a network such as, for example, the Internet 120. Network 115 can be, for example, a local area network (LAN), a wide area network WAN). The wireless communications devices 110 and 111 can be, for example, a tablet device, a netbook computer, a Wi-Fi enabled laptop, a mobile phone, a laptop computer, a personal digital assistant (PDA), a portable/mobile internet device and/or some other electronic communications device configured to wirelessly communicate with other devices.

In some embodiments, access point 100 can communicate with one or more wireless communication devices, such as wireless communication devices 110 and 111 using any suitable wireless communication standard such as, for example, Wi-Fi, Bluetooth, and/or the like. Specifically, access point 100 can be configured to receive data and/or send data through RF transceiver 130, when communicating with a wireless communication device. Furthermore, in some embodiments, an access point 100 of a network 115 can use one wireless communication standard to wirelessly communicate with a wireless communication device operatively coupled to the access point 100; while another access point 100′ (shown in FIG. 2) of the network 115 can use a different wireless communication standard to wirelessly communicate with a wireless communication device 112 operatively coupled to access point 100′. For example, as shown in FIG. 2, access point 100 can receive data packets through its RF transceiver 130 from wireless communication device 110 or 111 (e.g., a Wi-Fi enabled laptop) based on the Wi-Fi standard; while access point 100′ can send data packets from its RF transceiver (not shown) to the wireless communication device 112 (e.g., a Bluetooth-enabled mobile phone) based on the Bluetooth standard. Although two access points 100, 100′ and two access switches 106, 108, are shown in FIG. 2, it should be understood that any number of access points and access switches can be included.

In some embodiments, access point 100 can be operatively coupled to an access switch, such as an access switch 106 or an access switch 108 shown in FIG. 2, by implementing a wired connection between communications interface 124 and the counterpart (e.g., a communications interface) of the access switch 106 or 108. The wired connection can be, for example, twisted-pair electrical signaling via electrical cables, fiber-optic signaling via fiber-optic cables, and/or the like. As such, access point 100 can be configured to receive data and/or send data through communications interface 124, which is connected with the communications interface of the access switch 106, when access point 100 is communicating with the access switch 106. Furthermore, in some embodiments, the access point 100′ can implement a wired connection with an access switch (e.g., access switch 106) operatively coupled to the access point 100; while the access point 100′ implements a different wired connection with another access switch (e.g., access switch 108) operatively coupled to the access point 108. As shown in FIG. 2, access point 100 can implement one wired connection such as twisted-pair electrical signaling to connect with access switch 106; while access point 100′ can implement a different wired connection such as fiber-optic signaling to connect with access switch 108.

Although not explicitly shown in FIG. 2, it should be understood that an access point 100 can be connected to one or more other access points, which in turn, can be coupled to yet one or more other access points. In such an embodiment, the collection of interconnected access points can define a wireless mesh network. In such an embodiment, the communications interface 124 of access point 100 can be used to implement a wireless connection(s) to the counterpart (e.g., a communications interface) of another access point(s). As such, access point 100 can be configured to receive data and/or send data through communications interface 124, which is connected with the communications interface of another access point, when access point 100 is communicating with that access point.

The access point 100 can provide, for example, client access, spectrum analysis, mesh, and bridging services to various client devices, such as communication devices 110, 111. In some embodiments, the access point 100 can support 802.11a/b/g as well as 802.11n. In such embodiments, the access points 100 can provide, for example, seamless mobility both indoors and outdoors, and enable scalable deployment of wireless voice over IP (VoIP), video, and real-time location services.

In some embodiments, the access point 100 can provide band steering, client load balancing, dynamic authorization, quality of service (QoS), bandwidth controls, dynamic call admission control (CAC), and/or other services, all of which combine to provide a more consistent user experience as traffic is more evenly distributed across access points and/or frequency bands (e.g., the 2.4 GHz band and the 5.0 GHz band). This also can improve scalability, providing the same consistent user experience for thousands of mobile users and devices.

In some embodiments, when the access point 100 is operative, the access point 100 can automatically monitor the data integrity and RF signal strength of wireless channels, and continually tune for optimal RF channel and transmit power. Continuous scanning of the RF spectrum also allows early detection, classification, avoidance and remediation of performance degrading interference sources.

In some embodiments, the access point 100 can be, for example, a high-performance outdoor access point that support 802.11a/b/g/n. In some embodiments, the access point 100 can be placed in ruggedized, weatherproof enclosure that is suitable for extreme outdoor environments. Furthermore, in some embodiments, the access point 100 can support high-performance client access, long distance bridging, and mesh services.

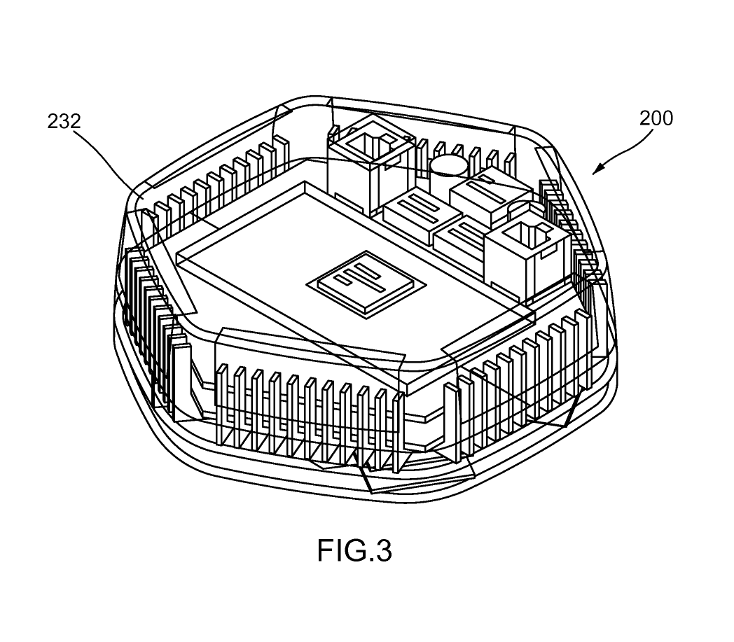

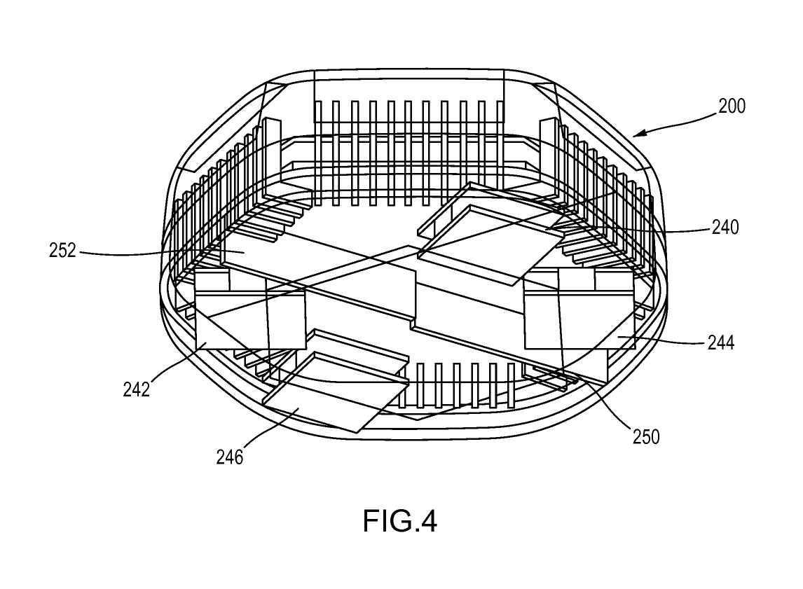

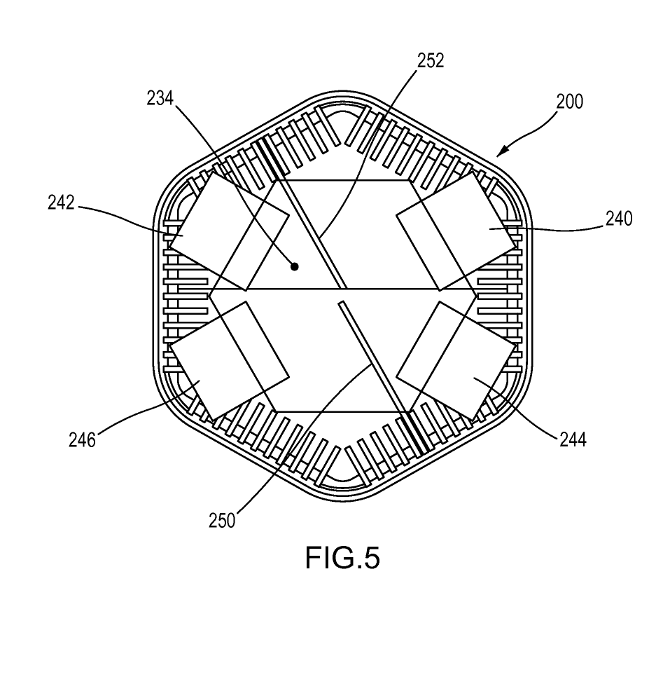

FIGS. 3-5 illustrate an access point, according to another embodiment. An access point 200 can be configured the same as or similar to, and function the same as or similar to the access point 100 described above. FIG. 3 is a top perspective view of the access point 200; FIG. 4 is a bottom perspective view of the access point 200 and FIG. 5 is a bottom view of the access point 200. The access point 200 can be, for example, a multiple input -multiple output (MIMO) access point that is enabled to operate concurrently in both the 2.4 GHz band (e.g., 802.11b/g/n) and the 5.0 GHz band (e.g., 802.11a/n).

The access point 200 includes an enclosure 232 that can be mounted to a ceiling, wall, wallplate, pole, or other surface or object. In this embodiment, the access point 200 includes six internal antennas mounted within the enclosure 232 adjacent to a heat sink plate 234. Specifically, the access point 200 includes three internal antennas configured to operate in the 2.4 GHz antennas, and three internal antennas configured to operate in the 5.0 GHz band. The access point 200 includes a first omnidirectional horizontally-polarized internal antenna 250, a first omnidirectional vertically-polarized internal antenna 240 and a second omnidirectional vertically-polarized internal antenna 242 that each operate in the 2.4 GHz band. The access point 200 also includes a second omnidirectional horizontally-polarized internal antenna 252, a third omnidirectional vertically-polarized internal antenna 244 and a fourth omnidirectional vertically-polarized internal antenna 246 that each operate in the 5.0 GHz band. In some embodiments, each of the vertically-polarized antennas 240, 242, 244, 246 can be disposed at a 5 degree down-tilt relative to the mounting surface to which the access point 200 is mounted.

The internal antennas of access point 200 are configured to support spatial diversity, pattern diversity, as well as polarization diversity. As described above, the access point 200 can include three distinct orientations of polarization for each of the 2.4 GHz band and the 5.0 GHz band. For example, the internal antennas that operate in the 2.4 GHz band (i.e., 250, 240, 242) can provide three distinct orientations of polarization, and the internal antennas that operate in the 5.0 GHz band (i.e., 252, 244, 246) can provide three distinct orientations of polarization. Specifically, an example pattern of polarization for each of the sets of internal antennas that operate in the 2.4 GHz band (250, 240, 242) and the 5.0 GHz band (252, 244, 246) can be similar to the example pattern shown in FIGS. 1D and 1E for an access point having two vertically-polarized internal antennas and a single horizontally-polarized internal antenna for a given band (e.g., 2.4 GHz band or 5.0 GHz band). Thus, in this embodiment, three distinct orientations of polarization can be viewed in at least two planes (e.g., a plane in a side view and a plane in a bottom view) for each set of internal antennas.

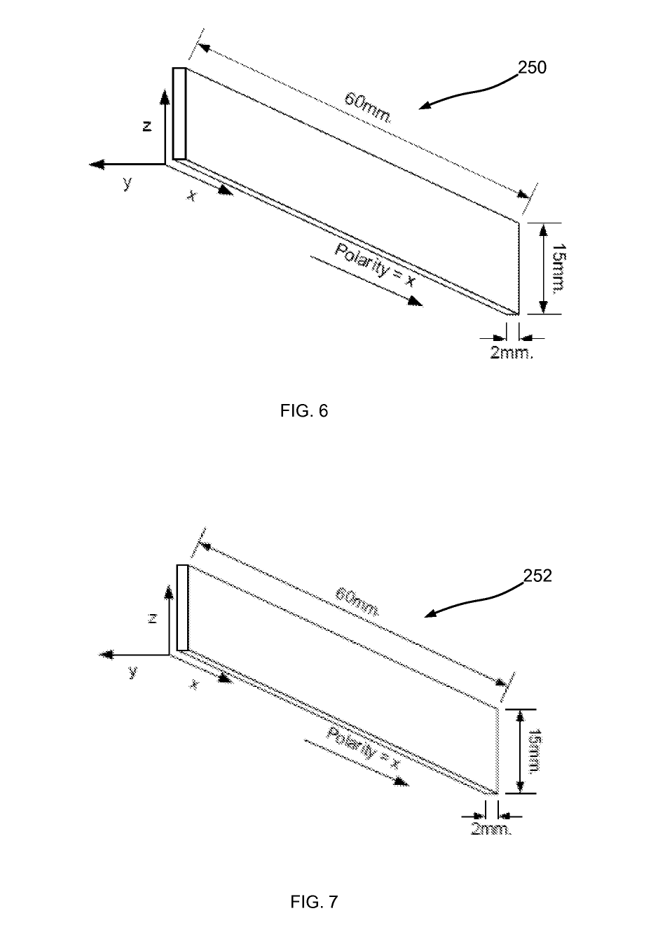

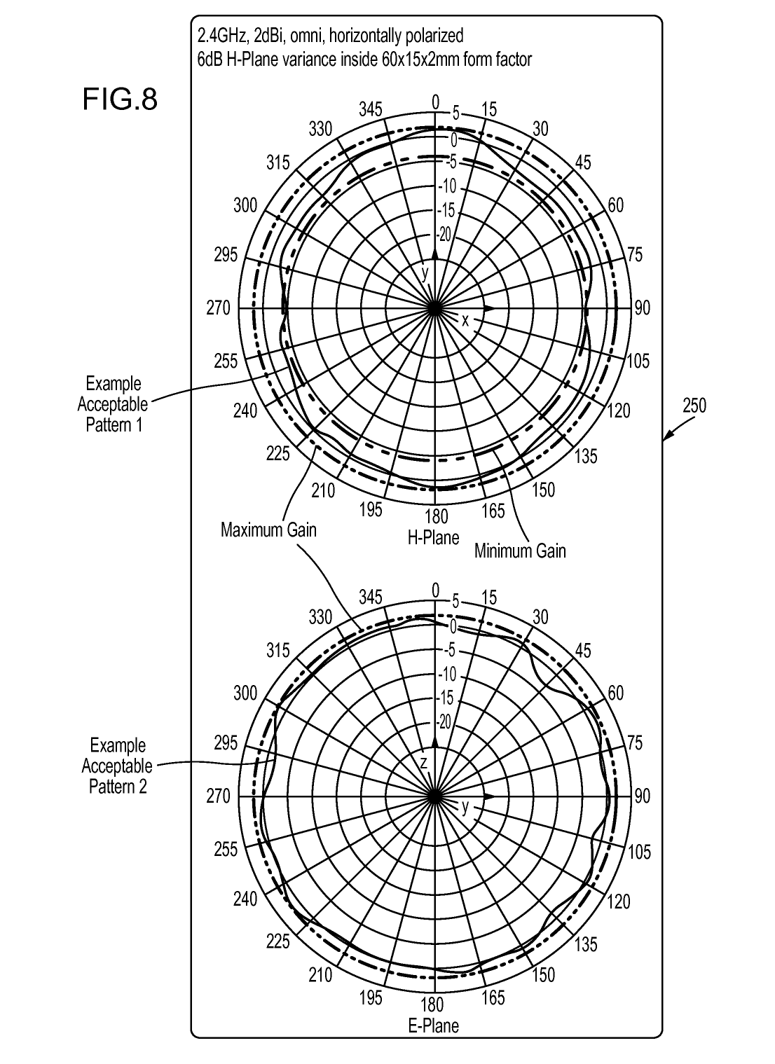

FIGS. 6 and 7 are schematic illustrations of the first horizontally-polarized internal antenna 250 and the second horizontally-polarized internal antenna 252, respectively, and illustrate form-factor characteristics (e.g., dimensions) of the first horizontally-polarized internal antenna 250 and the second horizontally-polarized internal antenna 252. FIGS. 8 and 9 illustrate radiation patterns of the first horizontally-polarized internal antenna 250 and the second horizontally-polarized internal antenna 252, respectively. As shown in FIGS. 6 and 7, the first horizontally-polarized internal antenna 250 and the second horizontally-polarized internal antenna 252 are structurally and dimensionally the same; for example, each has a form-factor of 60mm x 15mm x 2mm and has an orientation of polarization that is substantially horizontal when disposed within enclosure 232 (e.g., along an x-axis shown in FIGS. 6 and 7).

In some embodiments, the first horizontally-polarized internal antenna 250 can have a gain, for example, of 2 dBi, and the second horizontally-polarized internal antenna 252 can have a gain, for example, of 4 dBi. FIGS. 8 and 9 illustrate example specifications and details of acceptable radiation patterns, H-Plane gain and E-Plane gain for the first horizontally-polarized internal antenna 250 and the second horizontally-polarized internal antenna 252. As shown in FIG. 8, the outer dot-dash (—••—) line in the H-Plane diagram illustrates a maximum gain and the inner dot-dash (—••—) line in the H-Plane diagram illustrates a minimum gain for the first horizontally-polarized internal antenna 250. As shown in FIG. 8, the solid line in the H-Plane diagram is an example acceptable radiation pattern for the first horizontally-polarized internal antenna 250. The dot-dash (—••—) line in the E-Plane diagram of FIG. 8 is a maximum gain and the solid line is an example acceptable radiation pattern for the first horizontally-polarized internal antenna 250.

Similarly, as shown in FIG. 9, the outer dot-dash (—••—) line in the H-Plane diagram illustrates a maximum gain and the inner dot-dash (—••—) line in the H-Plane diagram illustrates a minimum gain for the second horizontally-polarized internal antenna 252. The solid line in the H-Plane diagram is an example acceptable radiation pattern for the second horizontally-polarized internal antenna 252. The dot-dash (—••—) line in the E-Plane diagram of FIG. 9 is a maximum gain and the solid line is an example acceptable radiation pattern for the second horizontally-polarized internal antenna 252.

As shown, for example, in FIG. 8, a 6 dB H-Plane variance corresponds to an acceptable pattern for the first horizontally-polarized internal antenna 250 that can vary from, for example, 2 dBi to −4 dBi around the extent of the horizontal pattern. This variance can provide acceptable MIMO performance of the access point 200, and less or more variance can be undesirable. This variance can be in the form of a bias towards two lobes (not shown), or it can be in the form of a rapid variance across a sequence of small sectors, or anything in-between. In some embodiments, as shown in FIG. 8, the gain for the first horizontally-polarized internal antenna 250 can vary from, for example, 2 dBi to −4 dBi around the 360 degrees horizontal plane.

As shown in FIG. 9, a 6 dB H-Plane variance corresponds to an acceptable pattern for the second horizontally-polarized internal antenna 252 that can vary from, for example, 4 dBi to −2 dBi around the extent of the horizontal pattern. This variance can provide acceptable MIMO performance of the access point, and less or more variance is undesirable. This variance can be in the form of a bias towards two lobes (not shown), or it can be in the form of a rapid variance across a sequence of small sectors, or anything in between. In some embodiments, as shown in FIG. 9, the gain for the second horizontally-polarized internal antenna 252 can vary from, for example, 4 dBi to −2 dBi around the 360 degrees horizontal plane.

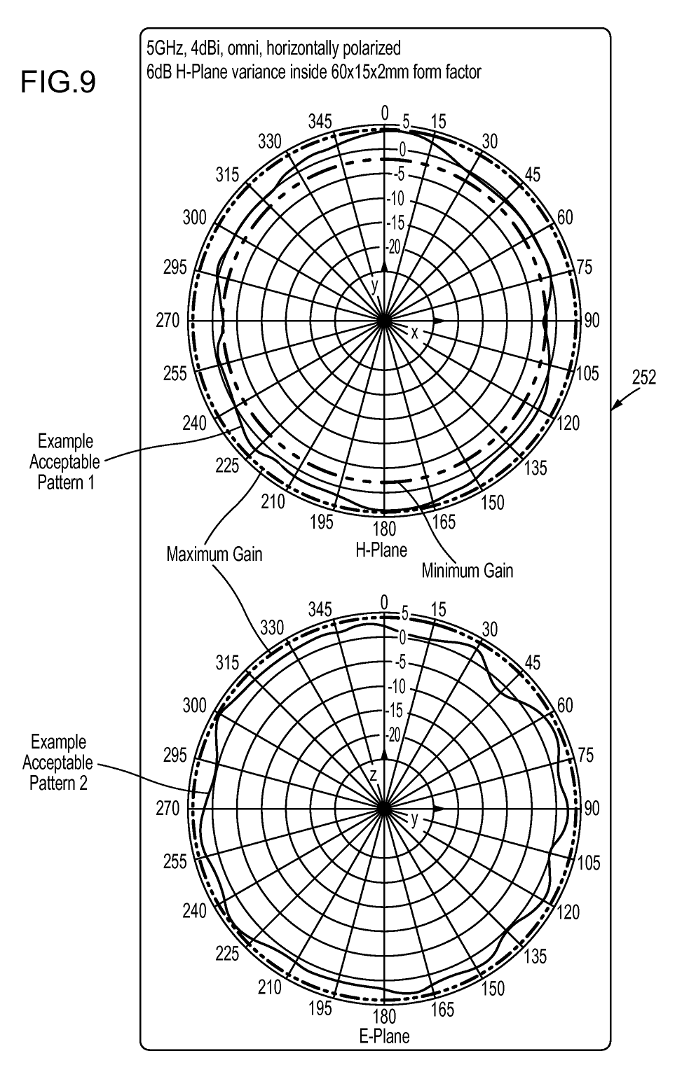

FIGS. 10 and 11 are schematic illustrations of the first vertically-polarized internal antenna 240 and the third vertically-polarized internal antenna 244, respectively. The second vertically-polarized internal antenna 242 can be configured the same as and function the same as the first vertically-polarized internal antenna 240 and the fourth vertically-polarized internal antenna 246 can be configured the same as and function the same as the third vertically polarized internal antenna 244 and are therefore not discussed in detail with reference to FIGS. 10-13. FIGS. 10 and 11 illustrate form-factor characteristics (e.g., dimensions) of the first vertically-polarized internal antenna 240 and the third vertically-polarized internal antenna 244, respectively. As shown in FIGS. 10 and 11, the first vertically-polarized internal antenna 240 and the third vertically-polarized internal antenna 244 each has the same form-factor, for example, a form-factor of 30 mm×30 mm×10 mm and has an orientation of polarization that is substantially vertical (e.g., along a z-axis shown in FIGS. 10 and 11), but can have structural differences as shown in FIGS. 10 and 11. For example, a first portion 241 of the first vertically-polarized internal antenna 240 and a first portion 243 of the third vertically-polarized internal antenna 244 can be dimensionally the same (e.g., have the same length and width), but a second portion 245 of the first vertically-polarized internal antenna 240 and a second portion 247 of the third vertically-polarized internal antenna 244 can be dimensionally different (have a different length and/or width). As shown in FIGS. 10 and 11, in this embodiment, the second portion 245 is larger (e.g., has a greater width and greater length) than the second portion 247.

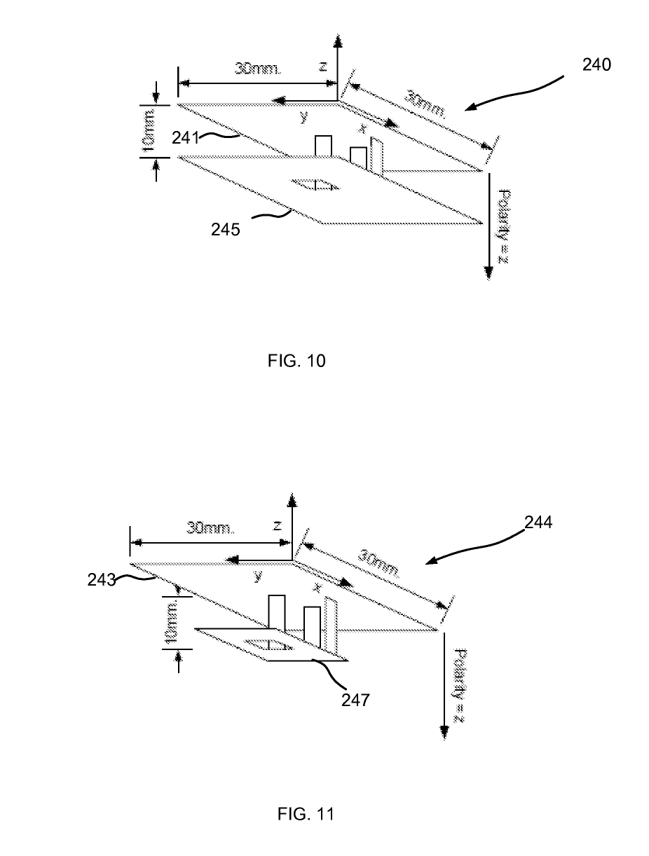

FIGS. 12 and 13 illustrate example specifications and details of acceptable radiation patterns, H-Plane gain and E-Plane gain for the first vertically-polarized internal antenna 240 and the third vertically-polarized internal antenna 244, respectively. As shown in FIG. 12, the outer dot-dash (—••—) line in the H-Plane diagram illustrates a maximum gain and the inner dot-dash (—••—) line in the H-Plane diagram illustrates a minimum gain for the first vertically-polarized internal antenna 240. As shown in FIG. 12, the solid line in the H-Plane diagram is an example acceptable radiation pattern for the first vertically-polarized internal antenna 240. The dot-dash (—••—) line in the E-Plane diagram of FIG. 12 is a maximum gain and the solid line is an example acceptable radiation pattern for the first vertically-polarized internal antenna 240..

Similarly, as shown in FIG. 13, the outer dot-dash (—••—) line in the H-Plane diagram illustrates a maximum gain and the inner dot-dash (—••—) line in the H-Plane diagram illustrates a minimum gain for the third vertically-polarized internal antenna 244. The solid line in the H-Plane diagram is an example acceptable radiation pattern for the third vertically-polarized internal antenna 244. The dot-dash (—••—) line in the E-Plane diagram of FIG. 13 is a maximum gain and the solid line is an example acceptable radiation pattern for the third vertically-polarized internal antenna 244. In some embodiments, the first vertically-polarized internal antenna 240 can have a gain, for example, of 3 dBi, and the third vertically-polarized internal antenna 244 can have a gain, for example, of 5 dBi.

As shown in FIG. 12, a 12 dB H-Plane variance corresponds to an acceptable pattern for the first vertically-polarized internal antenna 240 that can vary from, for example, 3 dBi to −9 dBi around the extent of the horizontal pattern. This variance can provide acceptable MIMO performance of the access point 100, and less or more variance can be undesirable. This variance can be in the form of a bias towards a wide sector as shown in the example acceptable pattern in FIG. 12, or it can be in the form of a rapid variance across a sequence of small sectors, or anything in-between. In some embodiments, as shown in FIG. 12, the gain for the first vertically-polarized internal antenna 240 can vary from, for example, 3 dBi to −9 dBi around the 360 degrees horizontal plane.

As shown in FIG. 13, a 12 dB H-Plane variance corresponds to an acceptable pattern for the third vertically-polarized internal antenna 244 that can vary from, for example, 5 dBi to −7 dBi around the extent of the horizontal pattern. This variance can provide acceptable MIMO performance of the access point 100, and less or more variance can be undesirable. This variance can be in the form of a bias towards a wide sector as shown in the example acceptable pattern in FIG. 13, or it can be in the form of a rapid variance across a sequence of small sectors, or anything in between. In some embodiments, as shown in FIG. 13, the gain for the third vertically-polarized internal antenna 244 can vary from, for example, 5 dBi to −7 dBi around the 360 degrees horizontal plane.

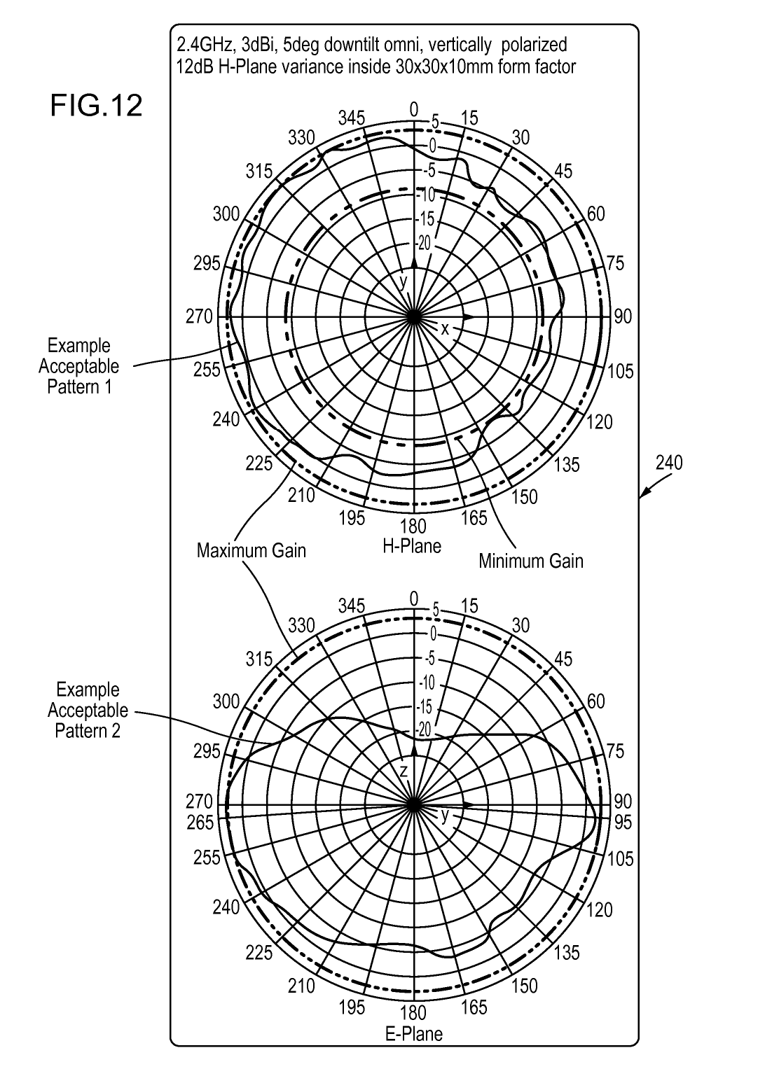

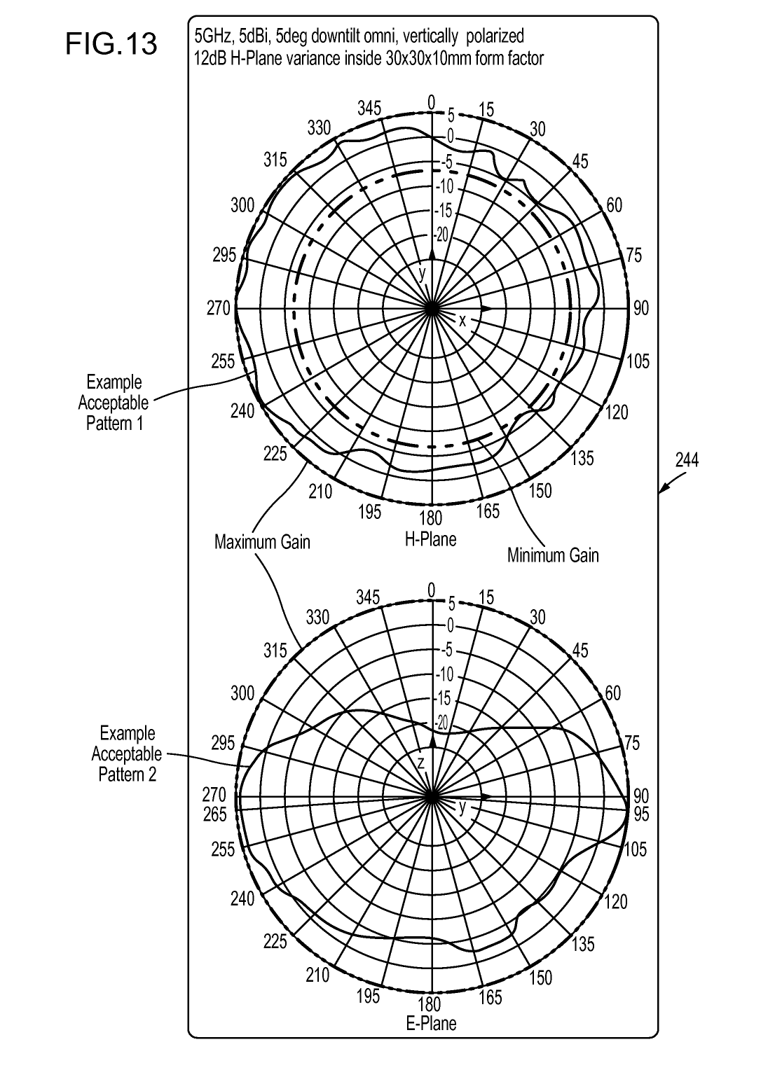

FIGS. 14 and 15 each illustrate an access point having internal antennas, according to another embodiment. An access point 300 can be configured the same as or similar to, and function the same as or similar to the access points 100 described above. The access point 300 can be, for example, a multiple output (MIMO) access point that is enabled to operate concurrently in both the 2.4 GHz band (e.g., 802.11b/g/n) and the 5.0 GHz band (e.g., 802.11a/n). FIG. 14 is a bottom perspective view of the access point 300 with a portion of an enclosure 332 of the access point 300 removed, and FIG. 15 is a bottom perspective view with the portion of the enclosure shown transparent.

The access point 300 includes the enclosure 332 that can be mounted, for example, to a ceiling or a wall or other support structure. In this embodiment, the access point 300 includes six internal antennas mounted within the enclosure 332 adjacent to a heat sink plate 334. Specifically, the access point 300 includes three internal antennas configured to operate in the 2.4 GHz band, and three internal antennas configured to operate in the 5.0 GHz band. The access point 300 includes a first omnidirectional vertically-polarized internal antenna 340, a first omnidirectional horizontally-polarized internal antenna 350 and a second omnidirectional horizontally-polarized internal antenna 352 that each operates in the 2.4 GHz band. The access point 300 also includes a second omnidirectional vertically-polarized internal antenna 342, a third omnidirectional horizontally-polarized internal antenna 354 and a fourth omnidirectional horizontally-polarized internal antenna 356 that each operates in the 5.0 GHz band.

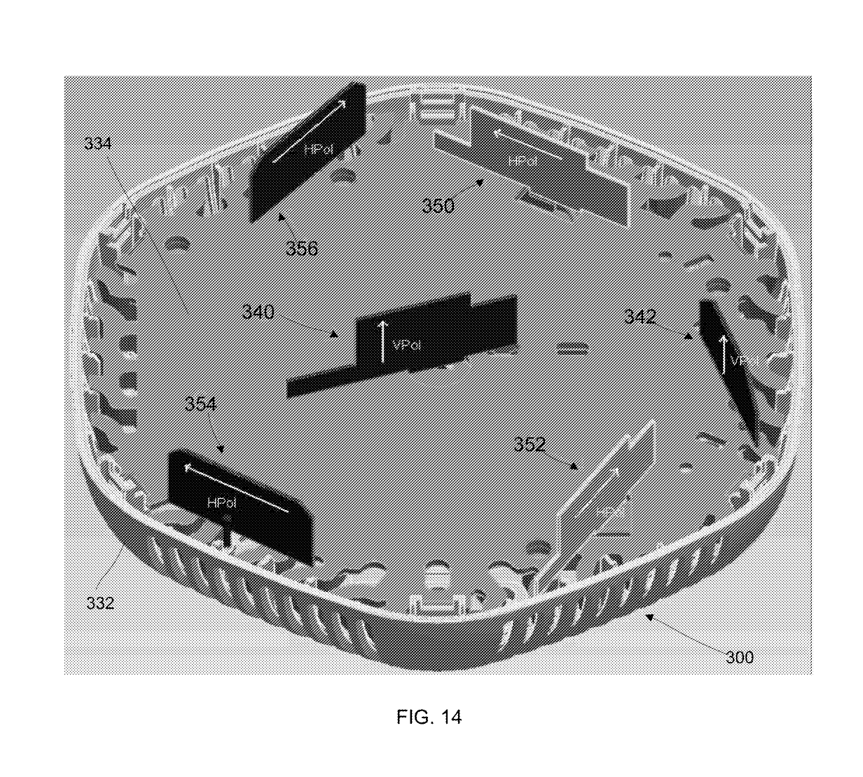

The internal antennas of access point 300 are configured to support spatial diversity, pattern diversity, as well as polarization diversity. To achieve polarization diversity, the access point 300 includes internal antennas with multiple orientations of polarization. Specifically, the access point 300 can include three distinct orientations of polarization in at least one plane for each of the 2.4 GHz band and the 5.0 GHz band. For example, the internal antennas that operate in the 2.4 GHz band (i.e., 340, 350, 352) can provide three distinct orientations of polarization, and the internal antennas that operate in the 5.0 GHz band (i.e., 342, 354, 356) can provide three distinct orientations of polarization. FIGS. 16A-16C illustrate example patterns of polarization for the sets of internal antennas that operate in the 2.4 GHz band (340, 350, 352) and the 5.0 GHz band (342, 354, 356). The example pattern of polarization for access point 300 can be similar to the pattern shown and described with respect to FIGS. 1B and 1C above for an access point having a single vertically-polarized internal antenna and two horizontally-polarized internal antennas for a given band (e.g., 2.4 GHz band or 5.0 GHz band).

FIG. 16A is a schematic illustration illustrating the polarization orientation for the six internal antennas of the access point 300, FIG. 16B is a side view (taken in the direction of arrow A in FIG. 16A) illustrating the polarization orientation for the three internal antennas (340, 350, 352) of the access point 300 that operate in the 2.4 GHz band, and FIG. 16C is a side view (taken in the direction of arrow B in FIG. 16A) illustrating the polarization orientation for the three internal antennas (342, 354, 356) of the access point 300 that operate in the 5.0 GHz band. As shown in the side view of FIG. 16B, an orientation of polarization P1 of the first vertically polarized internal antenna 340 is vertical, an orientation of polarization P2 of the first horizontally-polarized internal antenna 350 is in a first horizontal orientation, and orientation of polarization P3 of the second horizontally-polarized antenna 352, is in the same horizontal orientation as polarization orientation P2. Thus, in the side view, two distinct orientations of polarization of the access point 300 for the 2.4 GHz band exist. When viewed from a bottom view of the access point 300, as shown in FIG. 16A, the orientation of polarization P1 of the first vertically-polarized internal antenna 340 is substantially vertical and the orientation of polarization P2 of the first horizontally-polarized internal antenna 350 is in a first orientation and the orientation of polarization P2 of the second horizontally-polarized internal antenna 352 is in a second orientation different than the first orientation. Thus, in the bottom view, three distinct orientations of polarization of the access point 300 for the 2.4 GHz band exist. In other words, when viewed in a first plane (e.g., in the side view), the orientations of polarization of the two horizontally-polarized internal antennas 350, 352 are the same, but when viewed in another plane (e.g., a bottom view) the orientations of polarization of the two horizontally-polarized internal antennas 350, 352 are different.

Similarly, as shown in the side view of FIG. 16C, an orientation of polarization P4 of the second vertically-polarized internal antenna 342 is vertical, an orientation of polarization P5 of the third horizontally-polarized internal antenna 354 is in a first horizontal orientation, and an orientation of polarization P6 of the fourth horizontally-polarized antenna 356, is in the same horizontal orientation as polarization orientation P5. Thus, in the side view, two distinct orientations of polarization of the access point 300 for the 5.0 GHz band exist. When viewed from a bottom view of the access point 300, as shown in FIG. 16A, the orientation of polarization P4 of the second vertically-polarized internal antenna 342 is substantially vertical and the orientation of polarization P5 of the third horizontally-polarized internal antenna 354 is in a first orientation and the orientation of polarization P6 of the fourth horizontally-polarized internal antenna 356 is in a second orientation different than the first orientation. Thus, in the bottom view, three distinct orientations of polarization of the access point 300 for the 5.0 GHz band exist. In other words, when viewed in a first plane (e.g., in the side view), the orientations of polarization of the two horizontally-polarized internal antennas 354, 356 are the same, but when viewed in another plane (e.g., a bottom view) the orientations of polarization of the two horizontally-polarized internal antennas 354, 356 are different.

The multiple orientations of polarization allow the access point 300 to provide for polarization diversity in addition to spatial and pattern diversity provided for by the physical location of the internal antennas relative to each other for the internal antennas operating in the 2.4 GHz band and for the internal antennas operating in the 5.0 GHz band.

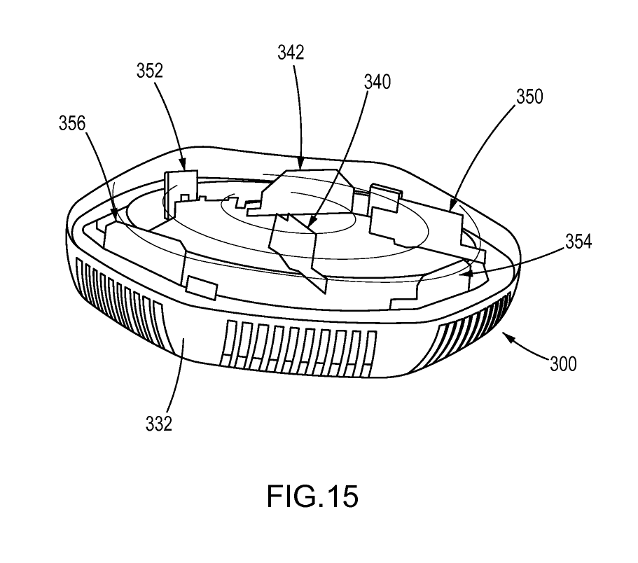

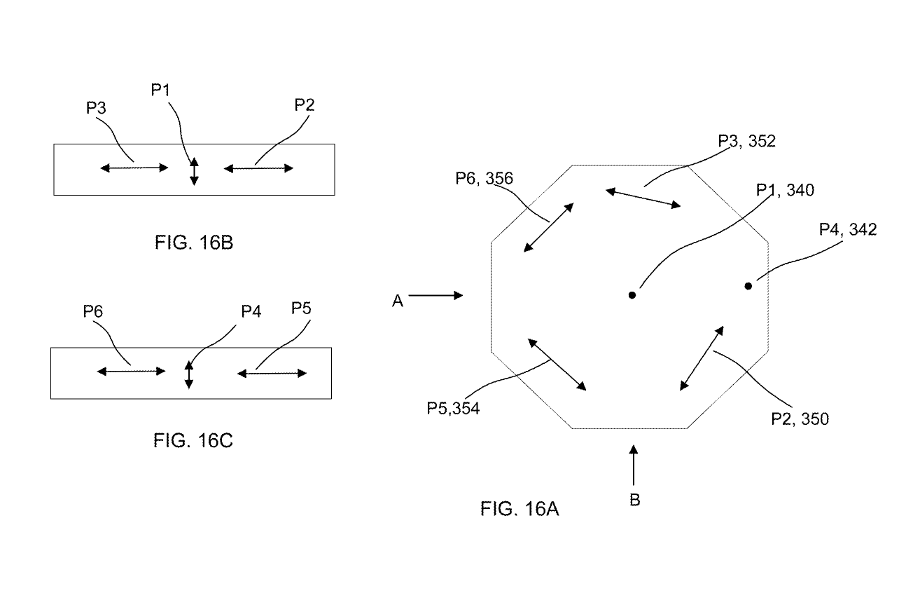

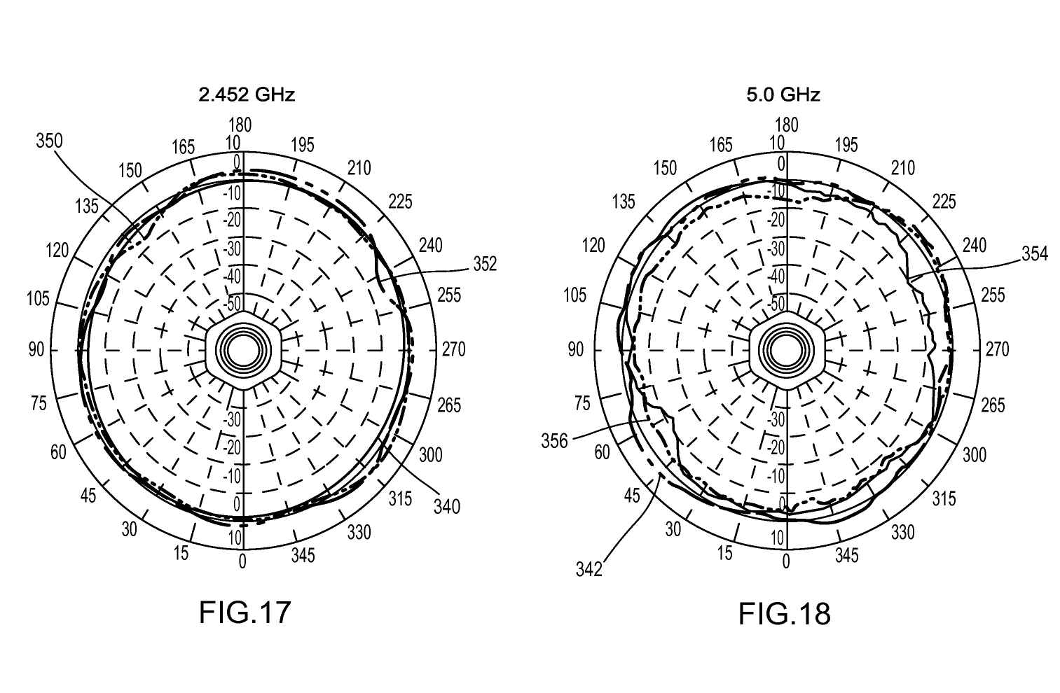

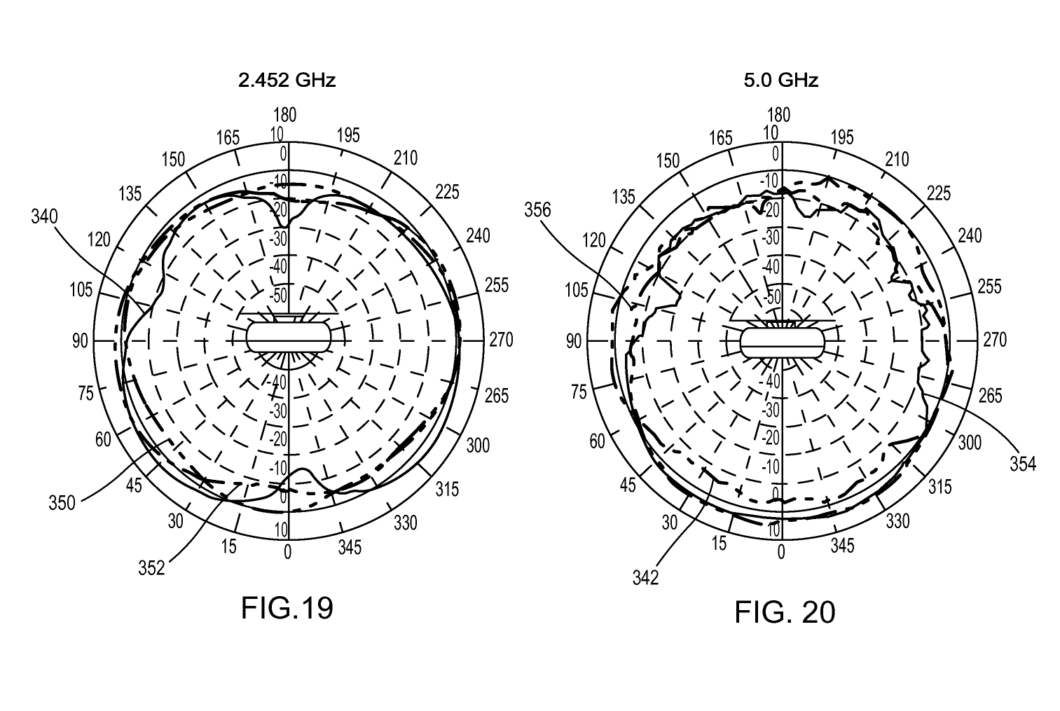

FIGS. 17 and 18 each provide graphical depictions of horizontal-plane radiation patterns (omnidirectional) for the internal antennas of the access point 300 operating in the 2.4 GHz band and the 5.0 GHz band, respectively. FIGS. 19 and 20 each provide graphical depictions of vertical-plane radiation patterns (omnidirectional) for the internal antennas of the access point 300 operating in the 2.4 GHz band and the 5.0 GHz band, respectively. FIGS. 17-20 illustrate relative field strengths of signals transmitted from or received by the internal antennas of the access point 300.

Specifically, FIG. 17 illustrates the horizontal-plane radiation pattern for internal antennas 340, 350 and 352 that operate in the 2.4 GHz band; FIG. 18 illustrates the horizontal-plane radiation pattern for internal antennas 342, 354 and 356 that operate in the 5.0 GHz band. The patterns shown in FIGS. 17 and 18 provide 360-degree even coverage. Similarly, FIG. 19 illustrates the vertical-plane radiation pattern (5 degree downtilt) for the internal antennas 340, 350 and 352 that operate in the 2.4 GHz band; FIG. 20 illustrates the vertical-plane radiation pattern for internal antennas 342, 354 and 356 that operate in the 5.0 GHz band. The patterns shown in FIGS. 19 and 20 provide maximum antenna gains along the outer edges of the access point 300, with a 5-degree downtilt.

As described herein, the internal antennas of an access point (100, 200, 300) are configured to support spatial diversity, pattern diversity, as well as polarization diversity. In some embodiments, the internal antennas of access point (100, 200, 300) can be configured to support, for example, cross-band isolation. Such embodiments can improve the performance of dual concurrent 2.4 GHz and 5 GHz access point with farther range, throughput, and coverage. In some embodiments, for example, the 2.4 GHz antennas can achieve a maximum gain of 3 dBi, and the 5 GHz antennas can achieve a maximum gain of 5 dBi.

Some of the embodiments of an access point device described herein refer to horizontal and vertical polarization. In an alternative embodiment, an access point can include one or more antennas that have a circular polarization. Such an antenna can send and receive an electromagnetic wave having a rotating electric field. For example, the electric field of the radio wave can rotate either clockwise or counterclockwise to provide different orientations of polarization within an access point in a similar manner as using a combination of antennas having a horizontal orientation and a vertical orientation. Thus, polarization diversity can alternatively be achieved using antennas with circular polarization or various combinations of antennas with circular polarization, horizontal polarization and vertical polarization. In yet other embodiments, an access point can include one or more antennas that have an elliptical polarization.

Some embodiments of an access point device described herein include omnidirectional antennas. In alternative embodiments, an access point device as described herein can include other type(s) of antennas that are not omnidirectional and/or a combination of omnidirectional and non-omnidirectional antennas. For example, other types of antennas can include a directional antenna, a patch antenna, etc.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

While various embodiments have been described above, it should be understood that they have been presented by way of example only, not limitation, and various changes in form and details may be made. Any portion of the apparatus and/or methods described herein may be combined in any combination, except mutually exclusive combinations. The embodiments described herein can include various combinations and/or sub-combinations of the functions, components and/or features of the different embodiments described.

What is claimed is:

1. An apparatus, comprising:
a processor disposed within an enclosure, the processor configured to connect one or more wireless devices to a network;
a first antenna having an orientation of polarization and disposed within the enclosure;
a second antenna having an orientation of polarization and disposed within the enclosure at a non-zero distance from first antenna; and
a third antenna having an orientation of polarization and disposed within the enclosure at a non-zero distance from each of the first antenna and the second antenna,
the orientation of polarization of the first antenna being different from the orientation of polarization of the second antenna, the orientation of polarization of the third antenna being different from the orientation of polarization of the first antenna and the orientation of polarization of the second antenna.

2. The apparatus of claim 1, wherein the orientation of polarization of the first antenna substantially corresponds to the orientation of polarization of the second antenna in a first plane and differs from the orientation of polarization of the second antenna in a second plane different than the first plane.

3. The apparatus of claim 1, wherein the first antenna is a first horizontally-polarized antenna, the second antenna is a second horizontally-polarized antenna, and the third antenna is a vertically-polarized antenna, each of the first antenna, the second antenna and the third antenna configured to operate in one of a 2.4 GHz band and a 5.0 GHz band.

4. The apparatus of claim 1, wherein the first antenna is a first vertically-polarized antenna, the second antenna is a second vertically-polarized antenna, and the third antenna is a horizontally-polarized antenna, each of the first antenna, the second antenna and the third antenna configured to operate in one of a 2.4 GHz band and a 5.0 GHz band.

5. The apparatus of claim 1, wherein the first antenna, the second antenna and the third antenna are each configured to operate within a 2.4 GHz band, the apparatus further comprising:
a fourth antenna disposed within the enclosure at a non-zero distance from the first antenna and the second antenna;
a fifth antenna disposed within the enclosure at a non-zero distance from the first antenna, the second antenna, the third antenna and the fourth antenna; and
a sixth antenna disposed within the enclosure at a non-zero distance from the first antenna, the second antenna, the third antenna, the fourth antenna and the fifth antenna, each of the fourth antenna, the fifth antenna and the sixth antenna configured to operate within a 5.0 GHz band,
the fourth antenna having an orientation of polarization different from an orientation of polarization of the fifth antenna, the sixth antenna having an orientation of polarization different from the orientation of polarization of the fourth antenna and the orientation of polarization of the fifth antenna.

6. The apparatus of claim 1, wherein the first antenna, the second antenna and the third antenna are each configured to operate within a 2.4 GHz band, the apparatus further comprising:
a fourth antenna disposed within the enclosure at a non-zero distance from the first antenna and the second antenna;
a fifth antenna disposed within the enclosure at a non-zero distance from the first antenna, the second antenna, the third antenna and the fourth antenna; and
a sixth antenna disposed within the enclosure at a non-zero distance from the first antenna, the second antenna, the third antenna, the fourth antenna and the fifth antenna, the fourth antenna, the fifth antenna and the sixth antenna, each of the fourth antenna, the fifth antenna and the sixth internal antenna configured to operate within a 5.0 GHz band,
an orientation of polarization of the fourth antenna substantially corresponds to an orientation of polarization of the fifth antenna in a first plane and differs from the orientation of polarization of the fifth antenna in a second plane different than the first plane.

7. The apparatus of claim 1, wherein the first antenna, the second antenna and the third antenna each has a defined radiation pattern and has an orientation of polarization such that collectively the first antenna, the second antenna and the third antenna provide spatial diversity, pattern diversity, and polarization diversity for the apparatus.

8. An apparatus, comprising:
a processor disposed within an enclosure, the processor configured to connect one or more wireless devices to a network;
a first horizontally-polarized antenna disposed within the enclosure;
a second horizontally-polarized antenna disposed within the enclosure at a non-zero distance from the first horizontally-polarized antenna;
a first vertically-polarized antenna disposed within the enclosure at a non-zero distance from each of the first horizontally-polarized antenna and the second horizontally-polarized antenna;
a third horizontally-polarized antenna disposed within the enclosure at a non-zero distance from each of the first horizontally-polarized antenna, the second horizontally-polarized antenna and the first vertically-polarized antenna;
a fourth horizontally-polarized antenna disposed within the enclosure at a non-zero distance from each of the first horizontally-polarized antenna, the second horizontally-polarized antenna, the first vertically-polarized antenna, and the third horizontally-polarized antenna; and
a second vertically-polarized antenna disposed within the enclosure at a non-zero distance from each of the first horizontally-polarized antenna, the second horizontally-polarized antenna, the first vertically-polarized antenna, the third horizontally-polarized antenna, and the fourth horizontally-polarized antenna.

9. The apparatus of claim 8, wherein the first horizontally-polarized antenna, the second horizontally-polarized antenna and the first vertically-polarized antenna are each configured to operate within a 2.4 GHz band,
the third horizontally-polarized antenna, the fourth horizontally-polarized antenna and the second vertically-polarized antenna are each configured to operate within a 5.0 GHz band.

10. The apparatus of claim 8, wherein the first horizontally-polarized antenna has a first orientation of polarization and the second horizontally-polarized antenna has a second orientation of polarization, the first orientation of polarization substantially correspond to the second orientation of polarization in a first plane and differs from the second orientation of polarization in a second plane different than the first plane.

11. The apparatus of claim 8, wherein the third horizontally-polarized antenna has a first orientation of polarization and the fourth horizontally-polarized antenna has a second orientation of polarization, the first orientation of polarization substantially correspond to the second orientation of polarization in a first plane and differs from the second orientation of polarization in a second plane different than the first plane.

12. The apparatus of claim 8, wherein:
the first horizontally-polarized antenna, the second horizontally-polarized antenna and the first vertically-polarized antenna are collectively configured to provide spatial diversity, pattern diversity, and polarization diversity at the 2.4 GHz band,
the third horizontally-polarized antenna, the fourth horizontally-polarized antenna and the second vertically-polarized antenna are collectively configured to provide spatial diversity, pattern diversity, and polarization diversity at the 5.0 GHz band.

13. The apparatus of claim 8, wherein the first horizontally-polarized antenna, the second horizontally-polarized antenna and the first vertically-polarized antenna each has an orientation of polarization in at least one plane different from the orientation of polarization for the remaining of the third horizontally-polarized antenna, the fourth horizontally-polarized antenna and the second vertically-polarized antenna.

14. An apparatus, comprising:
a processor disposed within an enclosure, the processor configured to connect one or more wireless devices to a network;
a first antenna having a polarization of one of a vertical polarization and a horizontal polarization and disposed within the enclosure;
a second antenna having a polarization corresponding to the polarization of the first antenna and disposed within the enclosure at a non-zero distance from the first antenna; and
a third antenna disposed within the enclosure at a non-zero distance from each of the first antenna and the second antenna, the third antenna having a polarization opposite the polarization of the first antenna and the polarization of the second antenna,
the first antenna, the second antenna and the third antenna each having a defined radiation pattern and having an orientation of polarization such that collectively the first antenna, the second antenna and the third antenna provide spatial diversity, pattern diversity, and polarization diversity for the apparatus.

15. The apparatus of claim 14, wherein the first antenna, the second antenna and the third antenna are each configured to operate in one of a 2.4 GHz band and a 5.0 GHz band.

16. The apparatus of claim 14, wherein the first antenna, the second antenna and the third antenna each has an orientation of polarization in at least one plane different from the orientation of polarization for the remaining of the first antenna, the second antenna and the third antenna.

17. The apparatus of claim 14, wherein the first antenna, the second antenna and the third antenna each have a distinct orientation of polarization.

18. The apparatus of claim 14, wherein the first antenna has an orientation of polarization that substantially corresponds to an orientation of polarization of the second antenna in a first plane and differs from the orientation of polarization of the second antenna in a second plane different than the first plane.

19. The apparatus of claim 14, wherein the first antenna is a first horizontally polarized antenna, the second antenna is a second horizontally polarized antenna, and the third antenna is a vertically polarized antenna, each of the first antenna, the second antenna and the third antenna configured to operate within one of a 2.4 GHz band and a 5.0 GHz band.

20. The apparatus of claim 14, wherein the first antenna is a first vertically polarized antenna, the second antenna is a second vertically polarized antenna, and the third antenna is a horizontally polarized antenna, each of the first antenna, the second antenna and the third antenna configured to operate within one of a 2.4 GHz band and a 5.0 GHz band.

21. The apparatus of claim 14, wherein the first antenna, the second antenna and the third antenna are each configured to operate within a 2.4 GHz band, the apparatus further comprising:
a fourth antenna having a polarization of one of a horizontal polarization and a vertical polarization and disposed within the enclosure;
a fifth antenna having a polarization corresponding to the polarization of the fourth antenna and disposed within the enclosure at a non-zero distance from each of the first antenna, the second antenna, the third internal antenna and the fourth antenna; and
a sixth antenna having a polarization opposite the polarization of the fourth antenna and the polarization of the fifth antenna and disposed within the enclosure at a non-zero distance from the first antenna, the second antenna, the third antenna, the fourth antenna and the fifth antenna, each of the fourth antenna, the fifth antenna and the sixth antenna configured to operate within a 5.0 GHz band'
the fourth antenna having an orientation of polarization different from an orientation of polarization of the fifth antenna, the sixth antenna having an orientation of polarization different from the orientation of polarization of the fourth antenna and the orientation of polarization of the fifth antenna.

22. The apparatus of claim 14, wherein the first antenna, the second antenna and the third antenna are each configured to operate within a 2.4 GHz band, the apparatus further comprising:
a fourth antenna having a polarization of one of a horizontal polarization and a vertical polarization and disposed within the enclosure;
a fifth antenna having a polarization corresponding to the polarization of the fourth antenna and disposed within the enclosure at a non-zero distance from each of the first antenna, the second antenna, the third internal antenna and the fourth antenna; and
a sixth antenna having a polarization opposite the polarization of the fourth antenna and the polarization of the fifth antenna and disposed within the enclosure at a non-zero distance from the first antenna, the second antenna, the third antenna, the fourth antenna and the fifth antenna, each of the fourth antenna, the fifth antenna and the sixth antenna configured to operate within a 5.0 GHz band,
an orientation of polarization of the fourth antenna substantially corresponds to an orientation of polarization of the fifth antenna in a first plane and differs from the orientation of polarization of the fifth antenna in a second plane different than the first plane.
